(19) United States
(12) Patent Application Publication
(10) Pub. No.: US 2026/0336976 A1
(43) Pub. Date: Oct. 29, 2026

(54) EVALUATION OF A STATE OF AN ELEVATOR DOOR

(71) Applicant: Kone Corporation, Helsinki (FI)

(72) Inventors: Matti MUSTONEN, Helsinki (FI); Petri KUISMA, Helsinki (FI); Matti LIN, Helsinki (FI); Serge ROOSENDAAL, Helsinki (FI)

(73) Assignee: Kone Corporation, Helsinki (FI)

(21) Appl. No.: 19/555,371

(22) Filed: Mar. 3, 2026

(30) Foreign Application Priority Data
Apr. 28, 2025 (EP) 25172862.2

(51) Int. Cl. B66B 5/02; B66B 5/00; B66B 13/16

(52) U.S. Cl. CPC B66B 5/02; B66B 5/0031; B66B 13/16

(57) ABSTRACT

A method for evaluating an operation of a locking mechanism of an elevator door is provided, the method, performed by a computing system, comprises: receiving data descriptive of an operation of an elevator door motor of the elevator door during an opening cycle of the elevator door; determining an indicator value descriptive of the operation of the locking mechanism of an elevator door; comparing the indicator value to a reference value; setting a detection result to express one of the following: i) the operation of the locking mechanism is proper, ii) the operation of the locking mechanism is improper. Also, a computing system, an elevator system and a computer program are provided to.

### CROSS-REFERENCE TO RELATED APPLICATION

This application claims priority to European Patent Application No. 25172862.2 filed on Apr. 28, 2025, the entire contents of which are incorporated herein by reference.

### TECHNICAL FIELD

The invention concerns in general the technical field of elevators. More particularly, the invention concerns elevator doors.

### BACKGROUND

Correct operation of elevator doors is an important aspect in terms of safety and convenience of elevator passengers. In particular, timely opening the doors to enable passengers to enter and exit an elevator car plays an important role in avoiding undue delays in passenger transport, while ensuring that doors can be opened when the elevator car is in a position that enables safe movement between the elevator and a landing of the elevator system and ensuring that doors remain closed when the elevator car is in transit between landings is an important aspect of passenger safety.

In many elevator systems the elevator doors are automatically operated such that opening and closing the elevator doors is carried out via using a driving system arranged in the elevator car which driving system comprises an electric motor arranged to drive movement of the elevator doors under control of an elevator door controller. An elevator door is typically further provided with a locking mechanism that ensures keeping the elevator door closed when the elevator car is in transit between landings and that allows for opening the elevator door when the elevator car is positioned at a landing zone of a landing.

Correct and reliable operation of the locking mechanism is hence critical for safe operation of the elevator system. The locking mechanism is typically configured or calibrated upon manufacturing, installing or carrying out a maintenance operation to the elevator car such that it ensures keeping the elevator door closed when the elevator car is in transit between landings and allows for opening the elevator door when the elevator car is positioned at a landing zone. However, due to wear and tear of components associated with the elevator door as well as due to dust, dirt, etc. accumulating to the components associated with the elevator door, prolonged operation of the elevator car may result in compromised operation or even a malfunction of the locking mechanism and consequently resulting in compromised elevator door operation. Since malfunction of the locking mechanism such that it fails to keep the elevator door closed during transit and/or such that it fails to open the elevator door when the elevator car stops at a landing may seriously compromise passenger safety, early detection of possibly compromised operation of the locking system would be advantageous.

Therefore, the is a possibility to introduce solutions by means of which the malfunctioning of the elevator door, and even the elevator, may be prevented, or at least mitigated.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a computing system, an elevator system and a computer program for evaluating an operation of a locking mechanism of an elevator door.

The objects of the invention are reached by a method, a computing system, an elevator system and a computer program as defined by the respective independent claims.

According to a first aspect, a method for evaluating an operation of a locking mechanism of an elevator door is provided, the method, performed by a computing system, comprises:
receiving data descriptive of an operation of an elevator door motor of the elevator door during an opening cycle of the elevator door,
determining an indicator value descriptive of the operation of the locking mechanism of an elevator door, the indicator value is determined by integrating the data descriptive of the operation of the elevator door motor over a monitoring period during the opening cycle of the elevator door,
comparing the indicator value to a reference value,
setting, in accordance with a comparison between the indicator value and the reference value, a detection result to express one of the following: i) the operation of the locking mechanism is proper, ii) the operation of the locking mechanism is improper.

For example, the monitoring period may correspond to a compression period of the elevator door.

The reference value, in turn, may correspond to a value of a properly operating elevator door, the reference value generated in a corresponding manner to the determination of the indicator value.

The data descriptive of the operation of the elevator door may be at least one of the following: a force generated by the elevator door motor during the opening cycle of the elevator door; a torque generated by the elevator door motor during the opening cycle of the elevator door; an input current of the elevator door motor during the opening cycle of the elevator door.

According to a second aspect, a computing system for evaluating an operation of a locking mechanism of an elevator door is provided, the computing system is configured to:
receive data descriptive of an operation of an elevator door motor of the elevator door during an opening cycle of the elevator door,
determine an indicator value descriptive of the operation of the locking mechanism of an elevator door, the indicator value is determined by integrating the data descriptive of the operation of the elevator door motor over a monitoring period during the opening cycle of the elevator door,
compare the indicator value to a reference value,
set, in accordance with a comparison between the indicator value and the reference value, a detection result to express one of the following: i) the operation of the locking mechanism is proper, ii) the operation of the locking mechanism is improper.

For example, the computing system may be configured to apply a compression period of the elevator door as the monitoring period.

The computing system may be configured to apply a value of a properly operating elevator door as the reference value, the reference value generated in a corresponding manner to the determination of the indicator value.

Furthermore, the computing system may be configured to apply as the data descriptive of the operation of the elevator door at least one of the following: a force generated by the elevator door motor during the opening cycle of the elevator door; a torque generated by the elevator door motor during the opening cycle of the elevator door; an input current of the elevator door motor during the opening cycle of the elevator door.

Still further, the computing system may be at least one of: an elevator controller; an elevator door controller; a data centre; an edge device.

According to a third aspect, an elevator system is provided, the elevator system comprising:
an elevator door arranged moveable between an open position and a closed position;
a door driving system for driving a movement of the elevator door; and
a computing system according to the second aspect as defined above.

According to a fourth aspect, a computer program is provided, the computer program comprising instructions to cause the computing system according to the second aspect as defined above to execute the steps of the method according to the first aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1A illustrates schematically some aspects of an elevator system according to an example.

FIG. 1B illustrates schematically as a block diagram some logical elements of an elevator system according to an example.

FIG. 2 illustrates schematically some elements of a locking mechanism according to an example.

FIGS. 3A and 3B illustrate schematically profiles with respect to various parameters in relation to an opening cycle of an elevator door according to examples.

FIG. 4 illustrates schematically a method according to an example.

FIG. 5 illustrates schematically a computing system according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

In broad terms, the present invention relates to an evaluation of an operation of a locking mechanism of an elevator door. The evaluation of the operation of the locking mechanism is based data descriptive of an operation of the elevator door motor in a manner as described in a forthcoming description.

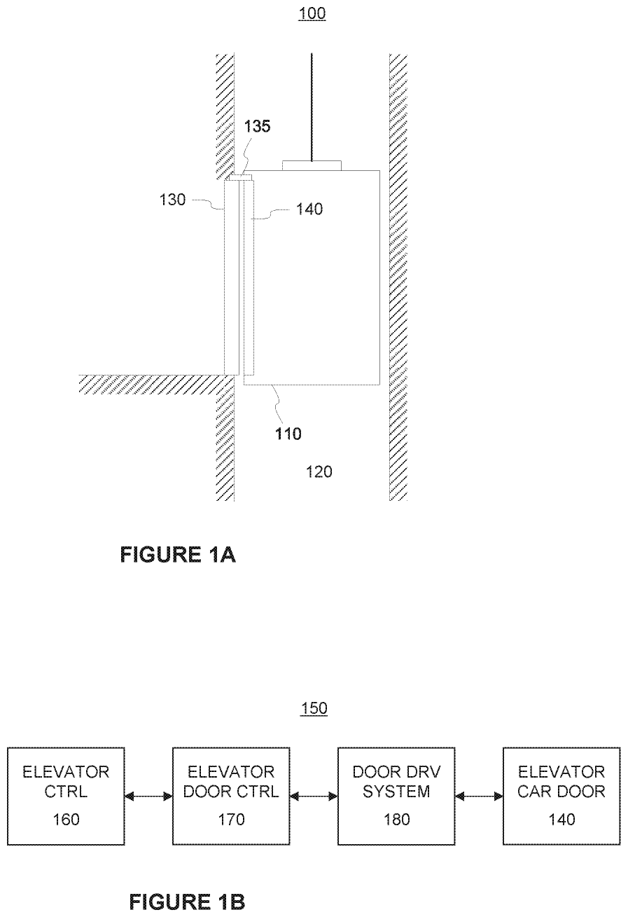

It is hereby referred to FIG. 1A in which some aspects of an elevator system 100 provided with automatic doors according to an example are schematically illustrated. The elevator system 100 comprises an elevator car 110 that may be moved in the vertical direction within an elevator shaft 120 to enable transporting passengers and/or cargo between landings of the elevators system 100. The elevator car 110 may be provided with a car door 140, wherein the car door 140 comprises a sliding door that is moveable between a closed position and an open position. The elevator 100 may further comprise a door coupler mechanism 135 that may be applied for temporarily coupling the car door 140 with a landing door 130 of the landing when the elevator car 110 resides within the landing zone of the landing such that when moving the car door 140 the landing door 130 moves between a closed position and an open position together with the car door 140.

The door coupler mechanism 135 may comprise coupling elements in the car door 140 and corresponding counter elements in the landing door 130 configured to engage each other upon moving the car door 140, thereby coupling the landing door 130 with the car door 140. In this regard, the coupling elements in the door coupler mechanism 135 are positioned with respect each other such that, when the elevator car 110 is moving along the elevator shaft 120 past the landing door 130, the coupling elements of the car door 140 are passed by the counter elements of the landing door 130. When the elevator car 110 is at the landing and the car door 140 is moved in order to open the landing door 130, the coupling elements of the car door 140 engage the counter elements of the landing door 130 and, consequently, when the car door 140 is moved by a door driving system arranged in the elevator car 110, the landing door 130 moves together with the car door 140.

In an example, the coupling elements may be arranged in a (first) railing assembly provided in the elevator car 110 above the car door 140 for guiding the movement of the car door 140 between the open and closed positions, whereas the counter elements may be arranged in a (second) railing assembly provided in the landing above the landing door 130 for guiding the movement of the landing door 130 between the open and closed positions. As an example in this regard, the coupling elements may comprise coupler vanes 120 (provided e.g. as sheet-metal vanes) projecting towards the landing door 130, where the coupler vanes 120 may be arranged such that they form a vertical ‘slot’ that has its open end directed towards the landing door 130, whereas the counter elements may comprise at least two elevator door lock rollers mounted on the landing door 130 in a position projecting towards the elevator shaft 120, the respective axes of the at least two elevator door lock rollers being substantially perpendicular to the plane of the landing door 130. As another example in this regard, the coupling mechanism may be implemented so that the coupler vanes 120 are arranged to end up between the elevator door lock rollers when the elevator car 110 resides at the landing floor.

FIG. 1B illustrates a block diagram of some logical elements of an elevator control system 150 according to an example. The elevator control system 150 may serve to control various aspect related to movement and operation of the elevator car 110. In this example, the elevator control system 150 is shown with an elevator controller 160 for controlling at least some aspects of movement of the elevator car 110 in the elevator shaft 120, a door driving system 180 for driving movement of the car door 140 of the elevator car 110 between a closed position and an open position; and a door controller 170 for operating the door driving system 180 and for monitoring at least one aspect of operation of the door driving system 180.

Along the lines described in the foregoing, the elevator controller 160 may be arranged to control at least some aspects of movement of the elevator car 110 in the elevator shaft 120. The elevator controller 160 is typically installed outside the elevator car 110, for example at a landing floor, in a machine room (if any), or in suitable location in the elevator shaft 120 or in its close proximity, and it may comprise or may be provided using one or more computing apparatuses comprising respective one or more processors arranged to execute one or more computer programs to provide at least some aspects of operation of the elevator controller 160. Hence, the elevator controller 160 may be provided as an elevator control apparatus (e.g. using a single computer apparatus) or as an elevator control system (e.g. using one or more computer apparatuses). The elevator controller 160 is communicatively coupled to the door controller 170, where the communicative coupling between the elevator controller 160 and the door controller 170 may be provided using a wired communication network or communication link, using a wireless communication network or communication link, or using a combination of a wireless communication network or communication link and a wireless communication network or communication link. The elevator controller 160 may be further communicatively coupled to one or more further elevator controllers that may be arranged for controlling at least some aspect of movement of respective elevator cars in other elevator shafts and/or to an elevator group controller arranged to control at least some aspects related to movement of a plurality of elevator cars in a plurality of elevator shafts.

Along the lines described in the foregoing, the door driving system 180 may be arranged to drive movement of the car door 140 between the closed position and the open position. In this regard, the door driving system 180 may operate under control of the door controller 170, e.g. in accordance with one or more door control signals received from the door controller 170. The door driving system 180 may comprise an electric motor and a motor controller arranged to control operation of the electric motor that is coupled to the car door 140 via a transmission system such that operation of the electric motor causes linear movement of the elevator car door 140 in a direction that is substantially parallel with an opening in a wall of the elevator shaft 120 at the landing, thereby enabling movement of the car door 140 between the closed and open positions. The transmission system may be arranged to convert the rotary motion provided by the electric motor into the linear movement of the car door 140. Characteristics of the transmission system may be selected in accordance with requirements of a specific implementation of the elevator car 110, the car door 140 and/or the door driving system 180, and the transmission system may involve, for example, one or more of the following: a belt drive, a chain drive, a gear train.

The door controller 170 is typically installed in the elevator car 110, for example in suitable location in the interior of the elevator car 110 (e.g. in a ceiling structure of the elevator car 110) or on the exterior of the elevator car 110 (e.g. on the roof of the elevator car 110). The door controller 170 may comprise or may be provided using a computing apparatus comprising one or more processors arranged to execute one or more computer programs to provide at least some aspects of operation of the door controller 170. Hence, the door controller 170 may be provided as a door controller apparatus. Along the lines described in the foregoing, the door controller 170 is communicatively coupled to the elevator controller 160, whereas the door controller 170 is further communicatively coupled to the door driving system 180, where the communicative coupling between the door controller 170 and the door driving system 180 may be provided using a wired or wireless communication network and/or communication link. Hence, the door controller 170 being involved in controlling a movement of the car door 140 may perform operation to cause moving the car door 140 in a first direction to open the car door 140 and move the car door 140 in a second direction that is opposite of the first direction to close the car door 140. For example, the door controller 170 may generate respective control signals to the door driving system 180. Additionally, the door controller 170 may enable setting and/or adjusting movement speed of the car door 170 with a control signal carrying data for the purpose(s).

In the following examples, where applicable, the term elevator door 130, 140 is applied to refer to one or both of the car door 140 and the landing door 130 as an editorial choice made in the interest of ensuring clarity and brevity of description via avoidance of extensive repetition of the terms car door 140 and landing door 130 throughout the examples. As already mentioned, the door coupler mechanism 135 may be arranged vice versa compared to one as explained in the foregoing description, i.e. so that the coupler vanes as the coupling elements are mounted on the landing door 130 and the elevator door lock rollers are mounted on the car door 140. Also, from this point of view the use of the term elevator door 130, 140 in a manner as described herein is justified.

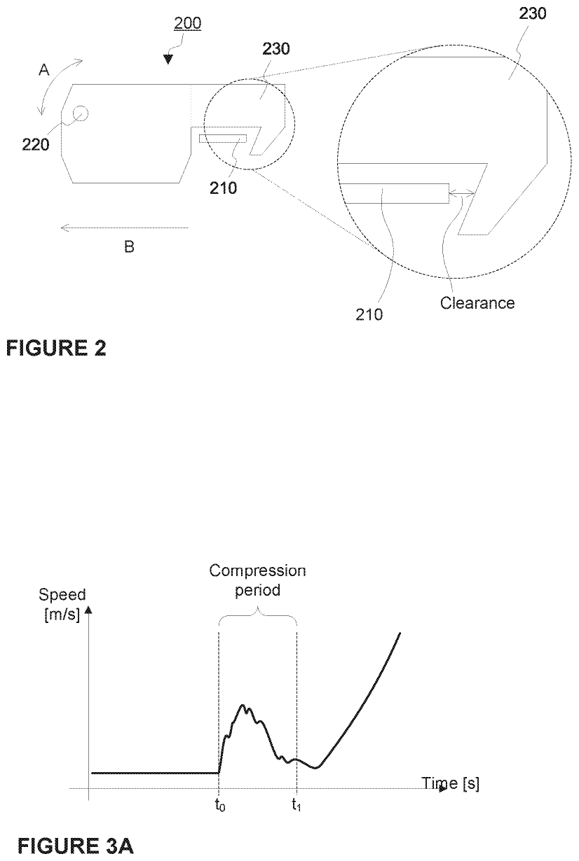

Next further aspects in relation to the invention are described by referring to FIG. 2 schematically illustrating an example of a locking mechanism of an elevator door at least in part. In other words, the car door 140 and/or the landing door 130 may be provided with a (respective) locking mechanism for locking and unlocking the car door 140 and/or the landing door 130. The locking mechanism may be applied to keep the car door 140 locked when the elevator car 110 is moving along the elevator shaft 120 between landings of the elevator system 100 and to keep the car door 140 unlocked when elevator car 110 is positioned at any of the landings of the elevator system 100. The locking mechanism for the landing door 130 may be applied to keep the landing door 130 locked when the elevator car 110 is not positioned at the landing and to keep the landing door 130 unlocked when the elevator car 110 is positioned at the landing.

FIG. 2 schematically illustrates a locking mechanism according to an example, where the locking mechanism comprises a lock latch assembly 200 for arrangement in the elevator door 130, 140 and a lock counterpart 210 for arrangement in a frame of the elevator door 130, 140. The lock latch assembly 200 may be rotatable about an axis 220 (as indicated by the curved arrow A) and it may comprise a lock hook portion 230 for engaging the lock counterpart 210. The lock latch assembly 200 and the lock counterpart 210 may be installed with respect to each other such that when the elevator door 130, 140 is in the closed position, the lock hook portion 230 may be brought via a rotating movement of the lock latch assembly 200 in a first direction (e.g. in the clockwise direction as in the illustration of FIG. 2) into a position where it engages the lock counterpart 210, whereas the lock counterpart 210 may be disengaged from the lock hook portion 230 via a rotating movement of the lock latch assembly 200 in a second direction that is the opposite of the first direction (e.g. the counter-clockwise direction as in the illustration of FIG. 2).

The locking mechanism may further comprise a lock hook actuation assembly (not shown in the illustration of FIG. 2) for rotating the lock latch assembly 200 by a predefined amount in the first direction such that the lock hook portion 230 engages the lock counterpart 210 in response to moving the elevator door 130, 140 to the closed position (e.g. against the direction indicated by the arrow B in FIG. 2) and for rotating the lock latch assembly 200 by the predefined amount in the second direction such that the lock hook portion 230 is disengaged from the lock counterpart 210 in response to moving the elevator door 130, 140 from the closed position towards the open position (e.g. to the direction indicated by the arrow B in FIG. 2). The lock hook actuation assembly may be provided using a suitable mechanical or electromechanical arrangement known in the art. As an example in this regard, the door coupler 135 may further serve as the lock hook actuation assembly such that operation of the door coupler 135 to couple the landing door 130 to the car door 140 upon starting to move the elevator door 130, 140 from the closed position towards the open position further serves to rotate the lock latch assembly 200 in the second direction (to cause disengaging the lock counterpart 210 from the lock hook portion 230) and such that operation of the door coupler 135 to uncouple the landing door 130 from the car door 140 after having brought the elevator door 130, 140 to the closed position further serves to rotate the lock latch assembly 200 in the first direction (to cause the lock hook portion 230 engaging the lock counterpart 210).

The locking mechanism may further comprise a locking member (not shown in the illustration of FIG. 2) for locking and unlocking the elevator door 130, 140. The locking member may be provided using a suitable mechanical or electromechanical arrangement known in the art. According to an example, the locking member (e.g. a locking pin) may be arranged to selectively disable or enable rotation of the lock latch assembly 200 under control of a control signal issued by the elevator door controller 220, thereby enabling locking the elevator door 130, 140 via disabling rotation of the lock latch assembly 140 and unlocking the elevator door 130, 140 via enabling rotation of the lock latch assembly 200. In another example, the locking member may be arranged to selectively disable or enable operation of the lock hook actuation assembly, thereby enabling locking the elevator door 130, 140 via disabling operation of the lock hook actuation assembly to rotate the lock latch assembly 200 and unlocking the elevator door 130, 140 via enabling operation of the lock hook actuation assembly to rotate the lock latch assembly 200.

As pointed out above, the illustration of FIG. 2 is a schematic one that serves to illustrate the operating principle of the exemplifying locking mechanism applicable for locking and unlocking the elevator door 130, 140 where the lock hook portion 230 of the lock latch assembly 200 may be caused to engage or disengage the lock counterpart 210 via the rotating movement of lock latch assembly 200. In this regard, the respective shapes and sizes of the lock latch assembly 200 and the lock counterpart 210, their arrangement with respect to each other as well as their orientation and/or position with respect to the elevator door 130, 140 may differ from that described with references to the illustration of FIG. 2 without departing from the scope of the present disclosure as far as their positions with respect to each other may be adjusted such that locking to prevent opening of the elevator door 130, 140 and unlocking to enable opening of the elevator door 130, 140 are provided for.

While the locking mechanism according to the example described above involves a relatively simple mechanical structure that serves as a proven solution for locking the elevator door 130, 140, it needs to be carefully calibrated in terms of lock clearance, i.e. in terms of the clearance between the lock hook portion 230 and the lock counterpart 210 (as illustrated in FIG. 2), to ensure reliable operation. In this regard, a sufficient lock clearance ensures undisturbed movement of the lock hook portion 230 with respect to the lock counterpart 210 without a contact between the two when rotating the lock latch assembly 200 while still ensuring locking that substantially prevents opening the elevator door 130, 140 without rotating the lock latch assembly 200. In contrast, less than sufficient lock clearance results in a contact between the lock hook portion 230 and the lock counterpart 210 upon rotating the lock latch assembly 200, which risks the lock hook portion 230 getting stuck with the lock counterpart 210 and, consequently, preventing opening of the elevator door 130, 140 even when unlocked. This, in turn, runs a risk of preventing passengers from entering or exiting the elevator car 110 upon arrival at the landing, where especially the latter may be considered to constitute a serious risk for convenience and safety of passengers.

The lock clearance may be calibrated to a reference value, for example, upon installing components of the elevator system 100 that have a direct or indirect effect on movement of the elevator door 130, 140 or upon carrying out a maintenance operation that may have an effect on respective positions of the car door 140 and the landing door 130 with respect to each other and/or with respect to the elevator car 110, thereby ensuring sufficient lock clearance and, consequently, reliable opening and closing of the elevator door 130, 140 at the landing. However, over time, the wear and tear of components of the elevator car 110, the car door 140 and/or the landing door 130 as well as sand, dust, dirt, etc. accumulating to the components of the elevator car 110, the car door 140, the landing door 130 and/or to the landing may result in a situation where the lock clearance (upon closing the elevator door 130, 140) is smaller than the reference value set upon calibration. Such a scenario, in turn, may result in the jamming the locking mechanism due to contact between the lock hook portion 230 and the lock counterpart 210 upon rotary motion of the lock latch assembly 200.

Referring now back to the door controller 170, in addition to controlling movement of the elevator door 130, 140 via controlling operation of the door driving system 180, the door controller 170 may be further arranged to monitor at least one aspect of movement of the elevator door 130, 140. This may be carried out, for example, via monitoring at least one aspect of operation of the door driving system 180 in moving the elevator door 130, 140. In this regard, the door controller 170 may receive and/or derive one or more parameters that are descriptive of aspects of the movement and/or position of the elevator door 130, 140, e.g. one or more of the following:
position of the elevator door 130, 140, e.g. in terms of the door position with respect to the (fully) open position and/or with respect to the (fully) closed position,
movement speed of the elevator door 130, 140,
power consumption of the electric motor of the door driving system 180 serving to drive movement of elevator door 130, 140,
torque of the electric motor of the door driving system 180 serving to drive movement of the elevator door 130, 140.

The position of the elevator door 130, 140 may be derived, for example, via monitoring a position of a component of the transmission system of the door driving system 180, which position is at least indirectly indicative of the (relative) position of the elevator door 130, 140 with respect to its open and closed positions. As an example in this regard, in case the transmission system of the door driving system 180 comprises a belt drive assembly, the measure of interest may comprise a position of (a predefined reference point in) a driving belt of the belt drive assembly and/or the traveling distance of the driving belt with respect to the fully closed or fully open position of the elevator door 130, 140. The movement speed of the elevator door 130, 140 may be derived, for example, via observing a time series of (at least two) positions of the elevator door 130, 140 over a time window.

The power consumption of the electric motor of the door driving system 180 may be monitored, for example, via directly monitoring a measure of power consumption of the electric motor or via monitoring one or more parameters that are indirectly descriptive of the power consumption of the electric motor. Examples of the latter include electric current and/or voltage supplied to the electric motor of the door driving system 180, e.g. the magnitude and/or phase of the electric current and/or the voltage supplied to the electric motor.

Respective indications of characteristics of the electric current and/or the voltage supplied to the electric motor may be obtained, for example, from the motor controller or from respective measurement arrangements applied for measuring the electric current and/or the voltage supplied to the electric motor. Along similar lines, an indication of the torque of the electric motor may be obtained, for example, from the motor controller or from a monitoring arrangement applied for measuring the torque of the electric motor.

The aspect of the door controller 170 monitoring of at least one aspect of movement of the elevator door 130, 140 may comprise the door controller 170 reading, receiving or deriving, upon using the door driving system 180 to open the elevator door 130, 140, respective values for the one or more parameters that are descriptive of movement of the elevator door 130, 140 according to a predefined schedule, e.g. at predefined time intervals. As a non-limiting example in this regard, predefined time interval may be chosen from the range from 10 to 100 milliseconds, e.g. 50 milliseconds.

According to an example, the door controller 170 may be arranged to monitor operation of the locking mechanism via observing power consumption of the electric motor of the door driving system 180 as a function of door position when moving the elevator door 130, 140 from the closed position towards the open position. In an example, this may be accomplished via deriving, based on respective values of one or more parameters that are descriptive of movement of the elevator door 130, 140 (e.g. the position of the elevator door 130, 140 and the power consumption of the electric motor) over a time period that corresponds to movement of the elevator door 130, 140 from the closed position towards the open position, a power consumption profile that is descriptive of the power consumption of the electric motor against a predefined parameter, such as a function of time or as a function of a door position. In this regard, observation of the power consumption profile may be carried out in an attempt to detect an (early) indication of a loss of sufficient lock clearance, which may be detected as increased power consumption in a certain portion of the power consumption profile, as described in the following examples in further detail.

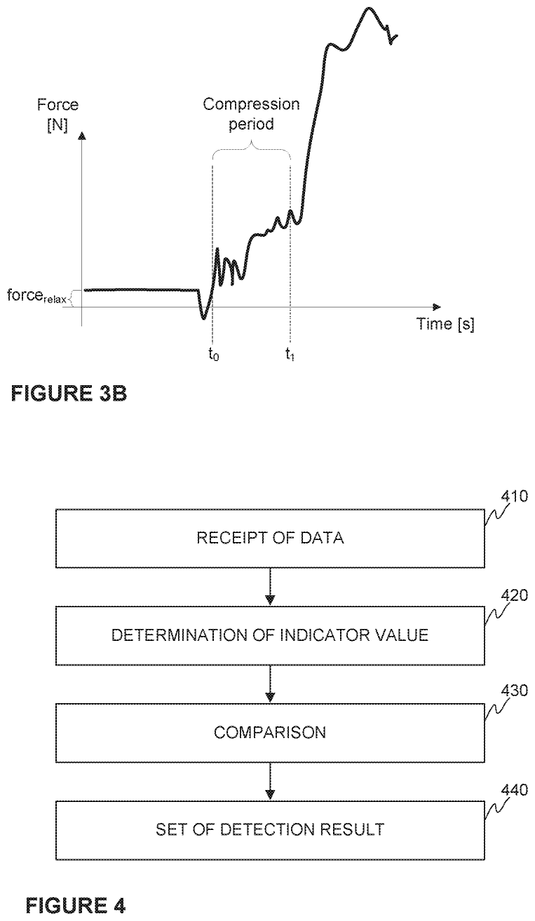

FIG. 3A illustrates a curve that represents an outline of a speed profile of an elevator door 130, 140 according to an example. As may be derived from FIG. 3 the elevator door 130, 140 does not move until so-called compression phase starts. The compression phase refers to a situation during an opening cycle of the elevator door 130, 140 wherein the coupler vane(s) contacts the respective door lock roller(s) until the release of lock hook portion 230 of the lock latch assembly 200 from the lock counterpart 210 through a rotation of an axis, i.e. the elevator door is unlocked. Hence, during the compression phase the speed of the door starts increasing but then reducing due to a resistance originating from the coupling and also from that the elevator door is locked until it is released. After the compression phase the real opening phase of the elevator door 130, 140 starts since the door leaf/leaves start opening and this may be seen in FIG. 3A as an increase of the opening speed of the elevator door 130, 140. The compression period, i.e. the compression phase, in FIG. 3A is indicated to occur between the instants of time denoted with t₀ and t₁. For avoidance of doubt the compression phase, i.e. its starting point and ending point, is possible to define at instants of time in a course of movement of the elevator door as shown in FIG. 3A. Correspondingly to above, it is possible to define a belt position when the compression phase starts as well as a belt position when the compression phase ends. The belt positions are derivable from data obtainable e.g. from the door drive system 180, such as from an encoder data therefrom. Still further, the compression phase may also be defined with speed of the belt thus representing a movement speed of the elevator door. The movement speed may e.g. be defined on a basis of a travel distance of the door defined by a series of (at least two) positions of the elevator door and a respective time window which travel distance is determinable e.g. from the encoder data and the time may be measured otherwise.

Correspondingly, FIG. 3B illustrates a belt force profile generated by the elevator door motor of the elevator door drive system 180 over at least in part over the opening cycle of the elevator door according to an example. The behavior of the force during the compression period defined by the instants of time t₀ and t₁ is derivable form FIG. 3B. As can be seen from FIG. 3B the force starts climbing up due to the above-mentioned reasons. After the compression period the belt force increases due to that the locking of the elevator door 130, 140 becomes released and the motion profile defined for the door opening cycle is followed to open the elevator door 130, 140 in an efficient manner (cf. period after the instant of time t₁). For avoidance of doubt, the compression periods in FIGS. 3A and 3B correspond to each other in timewise, i.e. the respective curves represent the same opening cycle. It is worth noting that the curves disclosed in FIGS. 3A and 3B are respective simplified illustrations of respective profiles occurring in a real-life implementation of the elevator system 100.

As already described in the foregoing description there are various reasons which may lead to an improper operation of the locking system. In practice the compromised operation at least comprises that the lock latch assembly 200 does not disengage the lock counterpart 210 in a desired manner as the locking system is designed and calibrated to operate. This may refer to an undesired increase in friction, for example, which in the worst case may correspond to a situation that the lock latch assembly 200 and the lock counterpart 210 do not disengage and the door does not open at all. Hence, in accordance with the present invention an operation of a locking mechanism of an elevator door 130, 140 is evaluated based on data descriptive of the operation of an elevator door motor as an indicator of a condition of the locking mechanism. In this regard, it is hereby referred to FIG. 4 illustrating schematically a method for evaluating the operation of the locking mechanism of the elevator door 130, 140. The method may be performed by an applicable computing system which may e.g. be the elevator door controller 170, the elevator controller 160 or another computing apparatus arranged to receive the data for performing the method.

In step 410 of the method as shown in FIG. 4, data descriptive of an operation of an elevator door motor of the elevator door 130, 140 is received during an opening cycle of the elevator door 130, 150. In other words, predefined type of data is obtained from the elevator system 100 that is descriptive of the operation of the elevator door 130, 140. In accordance with at least some embodiments of the invention the data received from the elevator system represents a door belt force, i.e. the force the door belt is driven and it may be obtained from the door motor of the elevator drive system 180. Hence, the data itself may directly be the force generated by the door motor or a torque generated by the door motor wherein these may be obtained with known sensor arrangements for example. Another approach may be to obtain data descriptive of a power consumption of the electric motor during the opening cycle of the elevator door, or at least during a part of it. An applicable parameter to represent the power consumption is the date descriptive of an input current supplied to the door motor. In other words, the input current correlates with the force generated by the electric door motor when driving the door belt. The data is received 410 at least over a predefined monitoring period that at least comprises the compression period, i.e. the period of time between the instants of time t₀ and t₁ as discussed in the foregoing description.

In response to the receipt 410 of the data, the computing system is configured to determine 420 an indicator value descriptive of the operation of the locking mechanism of an elevator door 130, 140. In accordance with the invention, the indicator value is determined 420 by integrating the data descriptive of the operation of the elevator door motor over a monitoring period during the opening cycle of the elevator door 130, 140. If the received data comprises data values outside the monitoring period, the computing system performing the step 420 of the method may be configured to filter such data values away from the data set. Thus, the data values applied for the determination 420 of the indicator value represent the monitoring period that in accordance with the present invention corresponds to the compression period. As said, the indicator value is determined 420 by integrating the function defined by the data values descriptive of the operation of the elevator door motor over the monitoring period. By applying the mathematical operation of integration is advantageous due to that it mitigates any sudden and/or accidental deviations in the data values during the monitoring period thus making the indicator value to represent the operation of the locking mechanism in an improved manner. The determination 420 of the indicator value may be performed with the following equation:

$${force}_{integral , compress} = {\int }_{{t}_{0}}^{{t}_{1}} ( {force}_{measured} - {force}_{relax} ) dt ,$$

wherein the determined force as the indicator value over the compression period is denoted with force_{integral,compress}, the measured force is denoted with force_{measured} and forceᵣₑₗₐₓ refers to force applied to belt prior to compression period, subtracted from the measured force to increase a sensitivity of the approach according to the present invention. As derivable from the equation, the integral is performed over the monitoring period corresponding to the compression period occurring between the instants of time t₀ and t₁. For avoidance of doubt, it is worth mentioning that even if the instant of time t₀ is indicated to refer to the instant when the contact occurs, it is also possible to define as an instant of time, or a position, or a speed, occurring before the contact. This also enables the determination of the force, i.e. the indicator value, in the above-described manner. Naturally, in such case the instant of time t₀, or a (trigger) position s₀ or a (trigger) speed v₀ (see below), is to be defined so that the indicator value generated is accurate enough for the purpose of the present invention. The application of the instant of contact as the instant of time t₀ defining the start of the monitoring period is a preferred approach due to its accuracy to represent the start of the phenomenon under interest.

In the description above at least some aspects of the present invention are described through an arrangement in which the monitoring period is defined as time window defined by instants of time t₀ and t₁. As mentioned, the monitoring period may also be defined as belt positions as data descriptive of the belt position is derivable from the door drive system, e.g. based on data obtained from an encoder of the door motor. Hence, the monitoring period, and thus the compression period, is possible to define as a first position so and as a second position s₁ of the door belt. In such an approach, the indicator value descriptive of the operation of the locking mechanism of an elevator door 130, 140 may be defined as a displacement of the door belt between the positions so and s₁. In other words, the determination 310 of the indicator may be performed by applying the above defined equation so that the force is determined by integrating the force over the displacement wherein the displacement is defined with the positions so and s₁. Naturally, the reference value is determined accordingly.

Still further, the monitoring period, and thus also the compression period may be defined with speed of the belt thus representing a movement speed of the elevator door. Hence, the monitoring period may start when a predefined speed v₀ is detected and end in response to a detection that another speed v₁ is reached wherein the speed v₁ is higher than the speed v₀. Thus, the corresponding integral over speed may be calculated to evaluate the operation of the locking mechanism of the respective elevator door 130, 140. Again, the reference value is determined accordingly to be applicable in the comparison of the indicator value defined based on the speed.

Worth noting is that the equation is defined with parameters representing the force, but the same approach is applicable with other parameters, such as a torque, or an input current or quadrature/torque producing current in vector control can be used instead of force in the formula because in an electrical motor where i_{d}*=0 control strategy is used the relation of the mentioned parameters is the following:

force=k₁*torque=k₂*i_{q}=k₂*i,

where k_1 and k_2 are constants. Worth noting is that the last equation k2*i is valid only for a specific control approach for specific motor types, i.e. the permanent magnet synchronous motors (PMSM) wherein the magnetization-axis current component is zero.

Next, the computing system is configured to perform a step of comparing 430 the indicator value as determined 420 to a reference value. The reference value represents a situation wherein the operation of the locking mechanism of the elevator door 130, 140 is proper. Thus, the reference value may be determined in various manners wherein it may be defined during the design procedure of the elevator system, and especially the locking mechanism of the elevator door 130, 140. In perhaps more preferred approach, the reference value is determined in the corresponding manner and the indicator value is determined 420, but the data used in the determination of the reference value is obtained from the elevator door 130, 140 when the locking mechanism is operating properly. For example, the data descriptive of the proper operation of the locking mechanism may be obtained during a maintenance, such as during an installation, of the elevator door 130, 140 and its sub-systems when the technician decides, e.g. through a predefined testing procedure, that the elevator door and the locking mechanism operate properly. The technician may e.g. drive the elevator door 130, 140 to open, and naturally to close, a predefined number of times and the data descriptive of the operation of the elevator door motor is gathered at least over the monitoring period for the purpose of generating the reference value. In case, there is generated a plurality of reference values a predefined mathematical operation, such as a statistical operation like an average function, may be applied to the plurality of values to generate the reference value for the purpose of the present invention.

Finally, the computing system is configured to set 440, in accordance with the comparison 430 between the indicator value and the reference value, a detection result to express one of the following: i) the operation of the locking mechanism is proper, ii) the operation of the locking mechanism is improper. The decision-making may be based on a detection of a predefined mismatch between the indicator value and the reference value. For example, if their difference is more than allowed, the detection of the improper operation of the locking mechanism may be expressed.

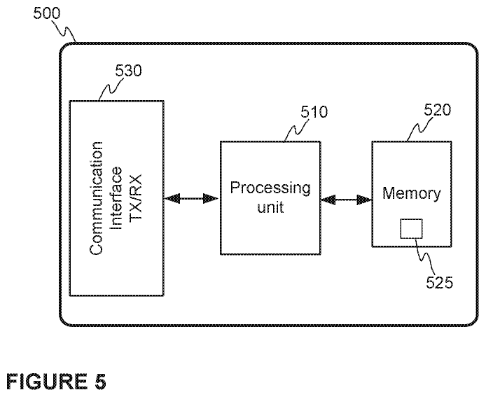

An example of such an apparatus configurable to implement the method as the computing system is schematically illustrated in FIG. 5. Thus, the apparatus of FIG. 5 may be configured to perform an evaluation of a locking mechanism of an elevator door 130, 140. For the sake of clarity, it is worthwhile to mention that the block diagram of FIG. 5 depicts some components of an entity that may be employed to implement a functionality of the apparatus. The apparatus of FIG. 5 comprises a processor 510 and a memory 520. The memory 520 may store data, such as pieces of data as described like the instants of time t₀ and t₁, or respective positions, defining the monitoring period during the opening cycle of the elevator door, but also computer program code 525 causing the association in the described manner. The apparatus may further comprise a communication interface 530, such as a wireless communication interface or a communication interface for wired communication, or both to communicate with other entities as described. The communication interface 530 may thus comprise one or more modems, antennas, and any other hardware and software for enabling an execution of the communication e.g. under control of the processor 510. Furthermore, I/O (input/output) components may be arranged, together with the processor 510 and a portion of the computer program code 525, to provide a user interface for receiving input from a user, such as from a technician, and/or providing output to the user of the apparatus when necessary. In particular, the user I/O components may include user input means, such as one or more keys or buttons, a keyboard, a touchscreen, or a touchpad, etc. The user I/O components may include output means, such as a loudspeaker, a display, or a touchscreen. The components of the apparatus may be communicatively connected to each other via data bus that enables transfer of data and control information between the components.

The memory 520 and at least a portion of the computer program code 525 stored therein may further be arranged, with the processor 510, to cause the apparatus to perform at least a portion of a method as is described herein. The processor 510 may be configured to read from and write to the memory 520. Although the processor 510 is depicted as a respective single component, it may be implemented as respective one or more separate processing components. Similarly, although the memory 520 is depicted as a respective single component, it may be implemented as respective one or more separate components, some, or all of which may be integrated/removable and/or may provide permanent/semi-permanent/dynamic/cached storage. The implementation of the processor(s) may be performed with programmable processors, but also dedicated circuits such as field-programmable gate arrays (FPGA), application specific circuits (ASIC), signal processors, etc.

The computer program code 525 may comprise computer-executable instructions that implement functions that correspond to steps implemented in the method when loaded into the processor 510 of the respective computing system 500. As an example, the computer program code 525 may include a computer program consisting of one or more sequences of one or more instructions. The processor 510 is able to load and execute the computer program by reading the one or more sequences of one or more instructions included therein from the memory 520. The one or more sequences of one or more instructions may be configured to, when executed by the processor 510, cause the apparatus, such as a computer, to perform a method as described. Hence, the apparatus may comprise at least one processor 510 and at least one memory 520 including the computer program code 525 for one or more programs, the at least one memory 520 and the computer program code 525 configured to, with the at least one processor 510, cause the apparatus implementing the computing system 500 to perform the method.

The computer program code 525, or at least some portion of it, may be provided e.g. a computer program product comprising at least one computer-readable non-transitory medium having the computer program code 525 stored thereon, which computer program code 525, when executed by the processor 510 causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 525 may comprise a proprietary application, such as computer program code for causing an execution of the method in the manner as described in the description herein.

Any of the programmed functions mentioned may also be performed in firmware or hardware adapted to or programmed to perform the necessary tasks.

For the sake of completeness, it is worthwhile to mention that the entity performing the method in the role of the computing system 500 may also be implemented with a plurality of apparatuses, such as the one schematically illustrated in FIG. 5, as a distributed computing environment corresponding to a computing system. For example, one of the apparatuses may be communicatively connected with the other apparatuses and e.g. share the data of the method, to cause another apparatus to perform at least one other portion of the method. As a result, the method performed in the distributed computing environment generates the control signal indicative of the assignment of the responsibility as described. For example, in some embodiments a first computing apparatus may perform the step denoted with 410 and the computing apparatus may refer to the door controller 170, for example. The first apparatus may be configured to transmit the determined indicator value to another computing apparatus referring e.g. to data centre or cloud wherein the other steps of the method, i.e. the steps denoted with 420 and 430 in FIG. 4 are executed. The respective entity may further generate a maintenance request to a predefine entity in a situation that a need for maintenance is detected as already described.

As already mentioned in the foregoing description the computing system 500 as shown in FIG. 5 may residing in a data centre or implemented as an edge device between the network and the elevator system. In some approaches at least some functionalities of the computing 500 to execute the method may be implemented in the elevator controller 160 or in the elevator door controller 170 as already mentioned in the foregoing description.

The present invention provides an improved solution for evaluating a condition of an elevator door and especially an operation of the locking mechanism of the elevator door

The present invention as described herein with the plurality of examples and aspects provides a more accurate evaluation of the operation of the locking mechanism than the prior art solutions. Yet, the approach is sophisticated and does not require substantial arrangements in the door mechanism as the information and data applied in the present invention is already available in the elevator system.

The specific examples provided in the description given above should not be construed as limiting the applicability and/or the interpretation of the appended claims. Lists and groups of examples provided in the description given above are not exhaustive unless otherwise explicitly stated.

What is claimed is:

1. A method for evaluating an operation of a locking mechanism of an elevator door, the method, performed by a computing system, comprises:
receiving data descriptive of an operation of an elevator door motor of the elevator door during an opening cycle of the elevator door,
determining an indicator value descriptive of the operation of the locking mechanism of an elevator door, the indicator value is determined by integrating the data descriptive of the operation of the elevator door motor over a monitoring period during the opening cycle of the elevator door,
comparing the indicator value to a reference value,
setting, in accordance with a comparison between the indicator value and the reference value, a detection result to express one of the following: i) the operation of the locking mechanism is proper, ii) the operation of the locking mechanism is improper.

2. The method according to claim 1, wherein the monitoring period corresponds to a compression period of the elevator door.

3. The method according to claim 1, wherein the reference value corresponds to a value of a properly operating elevator door, the reference value generated in a corresponding manner to the determination of the indicator value.

4. The method according to claim 1, wherein the data descriptive of the operation of the elevator door is at least one of the following: a force of a door belt generated by the elevator door motor during the opening cycle of the elevator door; a torque generated by the elevator door motor during the opening cycle of the elevator door; an input current of the elevator door motor during the opening cycle of the elevator door.

5. The method according to claim 1, wherein the indicator value is determined as at least one of the following: an integral of the characteristic of the elevator door motor over instants of time defining the monitoring period; an integral of the characteristic of the elevator door motor over positions of door belt defining the monitoring period; an integral of the characteristic of the elevator door motor over speeds of door belt defining the monitoring period.

6. A computing system for evaluating an operation of a locking mechanism of an elevator door, the computing system is configured to:
receive data descriptive of an operation of an elevator door motor of the elevator door during an opening cycle of the elevator door,
determine an indicator value descriptive of the operation of the locking mechanism of an elevator door, the indicator value is determined by integrating the data descriptive of the operation of the elevator door motor over a monitoring period during the opening cycle of the elevator door,
compare the indicator value to a reference value,
set, in accordance with a comparison between the indicator value and the reference value, a detection result to express one of the following: i) the operation of the locking mechanism is proper, ii) the operation of the locking mechanism is improper.

7. The computing system according to claim 6, wherein the computing system is configured to apply a compression period of the elevator door as the monitoring period.

8. The computing system according to claim 6, wherein the computing system is configured to apply a value of a properly operating elevator door as the reference value, the reference value generated in a corresponding manner to the determination of the indicator value.

9. The computing system according to claim 6, wherein the computing system is configured to apply as the data descriptive of the operation of the elevator door at least one of the following: a force of a door belt generated by the elevator door motor during the opening cycle of the elevator door; a torque generated by the elevator door motor during the opening cycle of the elevator door; an input current of the elevator door motor during the opening cycle of the elevator door.

10. The computing system according to claim 6, wherein the computing system is configured to determine the indicator value as at least one of the following: an integral of the characteristic of the elevator door motor over instants of time defining the monitoring period; an integral of the characteristic of the elevator door motor over positions of door belt defining the monitoring period; an integral of the characteristic of the elevator door motor over speeds of door belt defining the monitoring period.

11. The computing system according to claim 6, wherein the computing system is at least one of: an elevator controller; an elevator door controller; a data centre; an edge device.

12. An elevator system comprising:
an elevator door arranged moveable between an open position and a closed position;
a door driving system for driving a movement of the elevator door; and
a computing system according to claim 6.

13. A computer program comprising instructions to cause a computing system to execute the steps of the method of claim 1.
